(19) United States
(12) Patent Application Publication
(10) Pub. No.: US 2017/0348903 A1
(43) Pub. Date: Dec. 7, 2017

(54) Fabrication of Three-Dimensional Materials Gradient Structures by In-Flight Curing of Aerosols

(71) Applicant: Optomec, Inc., Albuquerque, NM (US)

(72) Inventors: Michael J. Renn, Hudson, WI (US); Douglas John Welter, Albuquerque, NM (US)

(21) Appl. No.: 15/674,458

(22) Filed: Aug. 10, 2017

Related U.S. Application Data
(63) Continuation-in-part of application No. 15/040,878, filed on Feb. 10, 2016.
(60) Provisional application No. 62/372,955, filed on Aug. 10, 2016.
(60) Provisional application No. 62/114,354, filed on Feb. 10, 2015.

(51) Int. Cl. B29C 64/112; B29D 11/00; B29C 64/129; B33Y 80/00; G02B 6/02; B33Y 10/00; B29K 105/16

(52) U.S. Cl. CPC B29C 64/112; G02B 6/02123; G02B 6/0208; B29D 11/00663; B33Y 10/00; B29C 64/129; B33Y 80/00; B29K 2105/162

(57) ABSTRACT

A method for fabricating three-dimensional structures. In-flight heating, evaporation, or UV illumination modifies the properties of aerosol droplets as they are jetted onto a target surface. The UV light at least partially cures photopolymer droplets, or alternatively causes droplets of solvent-based nanoparticle dispersions to rapidly dry in flight, and the resulting increased viscosity of the aerosol droplets facilitates the formation of free standing three-dimensional structures. This 3D fabrication can be performed using a wide variety of photopolymer, nanoparticle dispersion, and composite materials. The resulting 3D shapes can be free standing, fabricated without supports, and can attain arbitrary shapes by manipulating the print nozzle relative to the target substrate. Multiple materials may be mixed and deposited to form structures with compositionally graded material profiles, for example Bragg gratings in a light pipe or optical fiber, optical interconnects, and flat lenses.

### CROSS-REFERENCE TO RELATED APPLICATIONS

This application claims priority to and the benefit of the filing of U.S. Provisional Patent Application Ser. No. 62/372,955, entitled “AEROSOL JET® 3D MATERIALS GRADIENTS”, filed on Aug. 10, 2016. This application is also a continuation in-part application of U.S. patent application Ser. No. 15/040,878, entitled “FABRICATION OF THREE-DIMENSIONAL STRUCTURES BY IN-FLIGHT CURING OF AEROSOLS”, filed on Feb. 10, 2016, which application claims priority to and the benefit of the filing of U.S. Provisional Patent Application Ser. No. 62/114,354, entitled “MICRO 3D PRINTING”, filed on Feb. 10, 2015. The specifications and claims thereof are incorporated herein by reference.

### BACKGROUND OF THE INVENTION

### Field Of The Invention (Technical Field)

The present invention is related to the fabrication of 3D electrical and mechanical structures, microstructures, and nanostructures by in-flight curing of aerosol jetted nanoparticle and polymeric inks.

### Background Art

Note that the following discussion may refer to a number of publications and references. Discussion of such publications herein is given for more complete background of the scientific principles and is not to be construed as an admission that such publications are prior art for patentability determination purposes.

Three-dimensional printing is a rapidly evolving technology which promises to revolutionize additive manufacturing. With 3D printing, various structural materials such as plastics and metals can be fabricated into net-shaped structures without the need for subtractive machining or etching steps. There is little materials waste and the reduced processing steps promise to make 3D printing a cost-effective, green technology. Several 3D printing technologies are currently available today and it is useful to briefly compare these technologies to the current invention.

Stereolithography is an additive manufacturing process that works by focusing an ultraviolet (UV) laser onto a vat of photopolymer resin. With the help of computer-aided manufacturing or computer-aided design (CAM/CAD) software, the UV laser is used to draw a pre-programmed design or shape onto the surface of the photopolymer vat. Because photopolymers are photosensitive under ultraviolet light, the irradiated resin is solidified and forms a single layer of the desired 3D object. This process is repeated for each layer of the design until the 3D object is complete. Layer resolution of 50-150 μm is typical with lateral dimension approaching 10 μm. The process is generally limited to photopolymer materials and sacrificial structures are required to support overhangs.

Ink jet technologies are typically used to print graphitic and pigmented inks in 2D. Recent materials innovations enable ink jet printers to jet polymeric and metal nanoparticle inks. Generally the inks used in ink jet printing must have relatively low viscosity, meaning the inks will spread substantially after printing, thus limiting the minimum feature size and aspect ratio of the printed features. The ink jetter does not contact the substrate, but it is preferably in close proximity (less than 10 mm).

Extrusion technologies are popular for 3D printing of thermoplastic polymers. In this case, a thermal plastic is heated to the melting point in a nozzle and extruded onto a substrate. The plastic rapidly cools and solidifies on contacting the substrate, and a three-dimensional shape can be maintained. 3D parts are typically fabricated layerwise, with each layer consisting of a raster pattern of extruded filament. Overhangs can be fabricated by extruding a sacrificial support material and later dissolving or mechanically removing the support structure. Typically feature sizes are hundreds of microns, and materials are largely limited to thermoplastics and a few thermoset polymers, as well as conductive pastes. The nScrypt tool is capable of printing on 3D surfaces by robotic CAD/CAM control of the nozzle positioning.

### SUMMARY OF THE INVENTION (DISCLOSURE OF THE INVENTION)

The present invention is a method for fabricating a three-dimensional structure on a substrate, the method comprising propelling aerosol droplets from a deposition head toward the substrate, partially modifying a property of the aerosol droplets in-flight, and fully modifying the property of the aerosol droplets once they have been deposited as part of the three-dimensional structure. Modifying a property optionally comprises curing, for example ultraviolet (UV) light curing, or solidifying using electromagnetic radiation. In this embodiment aerosol droplets preferably comprise a photocurable polymer, and the fabricated three-dimensional structure comprises a cured polymer. The aerosol droplets optionally comprise solid particles dispersed in the photocurable polymer, and the fabricated three-dimensional structure comprises a cured polymer comprising embedded solid particles. The solid particles optionally comprise a ceramic, a metal, a fiber, or silicon. In another embodiment, the aerosol droplets comprise a solvent and modifying a property comprises evaporating the solvent. These aerosol droplets optionally comprise metal nanoparticles, in which case the method preferably further comprises irradiating the aerosol droplets with UV radiation, heating the metal nanoparticles, and heating the aerosol droplets sufficiently to at least partially evaporate the solvent. The method preferably further comprises continuing to irradiate the metal nanoparticles after they have been deposited, thereby at least partially sintering the metal nanoparticles.

The method optionally comprises tilting or translating the deposition head with respect to the substrate. The method optionally comprises fabricating an overhanging structure without requiring a sacrificial support or tilting the deposition head or the substrate. The standoff distance between the deposition head and the substrate is preferably at least 1 mm, and more preferably at least 2 mm. The method preferably comprises increasing the viscosity of the aerosol droplets in-flight, and preferably comprises irradiating the aerosol droplets with electromagnetic radiation in-flight and after the aerosol droplets have been deposited, optionally from more than one direction in-flight. The method optionally comprises heating the aerosol droplets with electromagnetic radiation in-flight and after the aerosol droplets have been deposited. The fabricated three-dimensional structure optionally comprises a structure selected from the group consisting of a micron-scale surface texture, a mechanical interposer, a precision spacer, a mechanical interposer comprising embedded electrical connectors, an enclosed, hollow structure, a mechanical scaffold, and a functional electrical wire.

The present invention is also a method for fabricating a three-dimensional structure on a substrate, the method comprising aerosolizing a first material and a second material; mixing droplets comprising the first material with droplets comprising the second material to form a mixed aerosol; propelling droplets of the mixed aerosol from a deposition head toward the substrate; partially modifying a property of the mixed aerosol droplets in-flight; and fully modifying the property of the mixed aerosol droplets once they have been deposited as part of the three-dimensional structure. The aerosol droplets optionally comprise a photocurable polymer and modifying a property optionally comprises curing or solidifying using electromagnetic radiation. In that embodiment the fabricated three-dimensional structure optionally comprises a light pipe or an optical fiber. The first and second materials preferably have different refractive indices. The mixing step preferably comprises varying the relative amounts of the first and second materials. The light pipe or optical fiber comprises a periodic variation of the relative compositions of the two materials along a length of the light pipe or optical fiber, preferably forming a Bragg grating. One of the materials can optionally be reflective or fluorescent. The exterior surface of the light pipe or optical fiber optionally comprises optical cladding, wherein the roughness of the exterior surface and/or the optical cladding is less than one micron. The optical cladding preferably has a lower refractive index than both a refractive index of the first material and a refractive index of the second material.

In another embodiment the three-dimensional structure optionally comprises an optical interconnect. The mixing step preferably comprises varying the relative amounts of the first and second materials, in which case the three-dimensional structure preferably comprises compositionally graded material profiles and/or materials gradients. In one such embodiment the three-dimensional structure comprises a flat lens comprising a first refractive index at an edge of the lens and a second refractive index at a center of the lens. The aerosol droplets optionally comprise a solvent and modifying a property optionally comprises evaporating the solvent. The aerosol droplets may comprise metal nanoparticles, the method further comprising irradiating the aerosol droplets with UV radiation; heating the metal nanoparticles; and heating the aerosol droplets sufficiently to at least partially evaporate the solvent; and continuing to irradiate the metal nanoparticles after they have been deposited, thereby at least partially sintering the metal nanoparticles. The method preferably further comprises tilting or translating the deposition head with respect to the substrate. The method optionally comprises fabricating an overhanging structure without requiring a sacrificial support or tilting the deposition head or the substrate. The standoff distance between the deposition head and the substrate is preferably at least 1 mm, and more preferably between 2 mm and 5 mm. The method preferably comprises increasing the viscosity of the aerosol droplets in-flight.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1A is a schematic illustrating a mechanism for three-dimensional printing with aerosol jets for vertical or lateral build of 3D structures.

FIG. 1B is a schematic showing more detail of vertical building of a 3D structure.

FIG. 1C is a schematic showing more detail of lateral building of a 3D structure.

FIGS. 2A-2C are images of an array of polymer posts printed according to an embodiment of the present invention. FIG. 2D is a graph showing the post build rate.

FIG. 3 is an image of an array of composite posts.

FIGS. 4A and 4B are perspective and top views, respectively, of an interposer printed in accordance with an embodiment of the present invention.

FIG. 5A shows three-dimensional jack-like structures printed using the offset approach shown in FIG. 1. FIG. 5B shows an open cone structure.

FIGS. 6A and 6B show a closed channel having an open interior along the length. FIG. 6C shows ink flowing on the inside of the channel.

FIGS. 7A and 7B show an individual antenna and an array of antennas, respectively, having an L-shape printed post. FIGS. 7C and 7D are images of 3D electrical components printed on a microchip.

FIG. 8A shows freestanding polymer springs fabricated by tilting the print head during printing. FIG. 8B shows the springs supporting a mass.

FIG. 9A is a graph showing the optical density of silver nanoparticles. FIG. 9B shows a 3D silver wire array printed with the in-situ illumination method.

FIGS. 10A-10F are images of various 3D shapes printed using UV polymers and on the fly curing.

FIG. 11 is a schematic of an apparatus of the present invention for mixing of two materials having electromagnetic curing capabilities.

FIG. 12 is an image of acrylic posts printed on the tip of a needle.

FIG. 13A is an image of a light pipe printed on an LED chip using the Aerosol Jet® process of the present invention.

FIG. 13B is an image of an array of light pipes each printed on an LED chip using the Aerosol Jet® process of the present invention.

FIG. 13C is an image of light coming through a light tube on an LED chip.

FIG. 14 is a schematic of selective light reflection in an optical fiber with periodic variation of refractive indices.

### DETAILED DESCRIPTION OF EMBODIMENTS OF THE INVENTION

The present invention is a method of making three-dimensional structures, such as structures comprising high aspect ratio features, using in-flight curing of aerosols and inks, and direct printing of liquid materials to fabricate three-dimensional, free standing, complex structures. Specifically, embodiments of the present invention combine patented Aerosol Jet® dispensing technology, such as that described in U.S. Pat. Nos. 7,674,671, 7,938,079, and 7,987,813, with an in-flight materials processing mechanism that enables liquid droplets to partially solidify before depositing on a surface. After the in-flight processing, the droplets can be deposited to form free standing structures. Some of the advantages of this approach include ultra-high resolution three-dimensional (3D) printing, with feature sizes down to 10 microns, lateral feature resolution to 1 micron, and vertical resolution to 100 nm. The aspect ratio of the free-standing structures can be more than 100, and the structures can be printed on nearly any surface and surface geometry by manipulating the tilt and location of the print head relative to those surfaces. Overhangs and closed cells can be printed directly, without using sacrificial support materials. Both metal and insulating materials can be processed, which enables the co-deposition of electronic materials for fabricating circuits in 3D. Furthermore, composite materials can be printed, which allow for the tailoring of the mechanical and electrical properties of the 3D structures. Ultraviolet (UV) polymers can be cured in-flight as they are impacting on the target, and low sintering temperatures enable metallization of plastics. Using an Aerosol Jet® process, practically any type of material and/or solvent can be printed. The large standoff from the substrate (typically a few millimeters) for this process enables high aspect printing without any z-axis motion. Sub-10 micron focusing of the aerosol jet enables creation of ultrafine features.

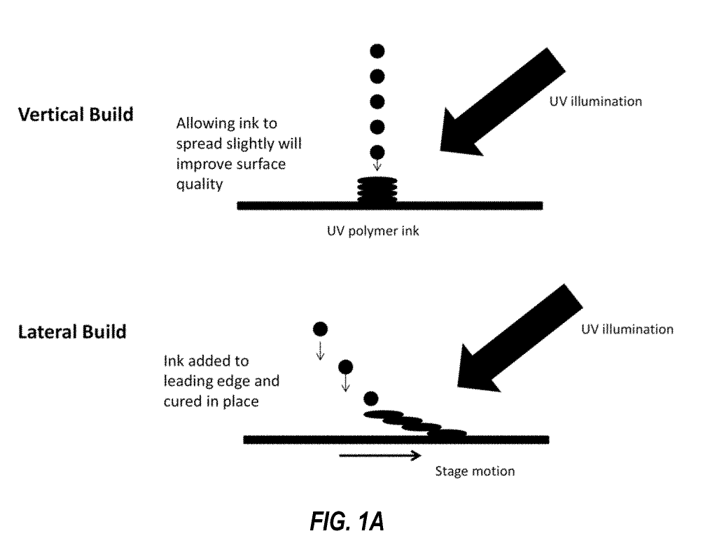

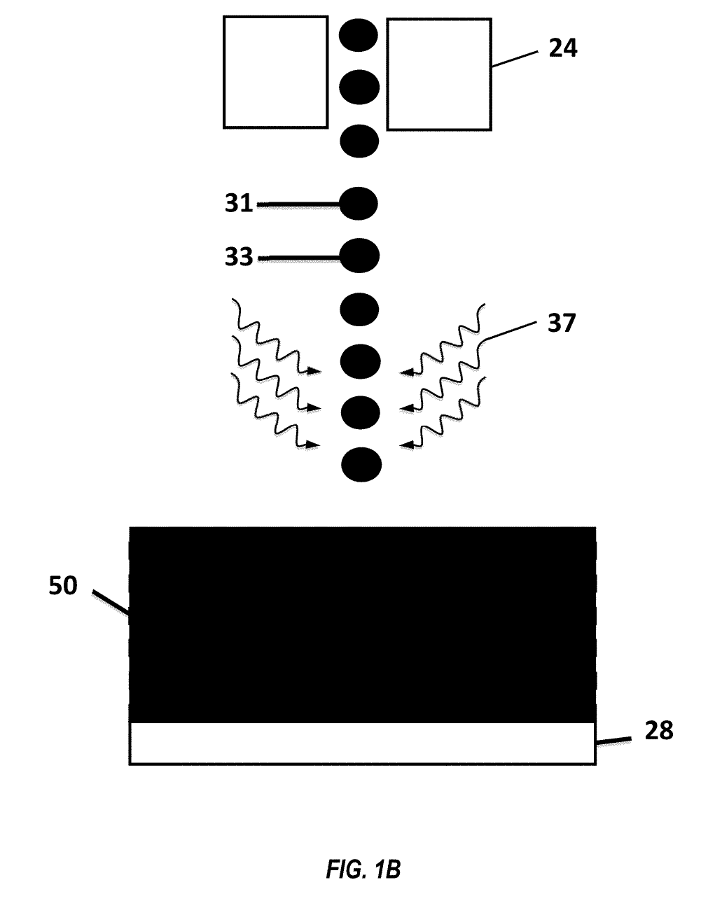

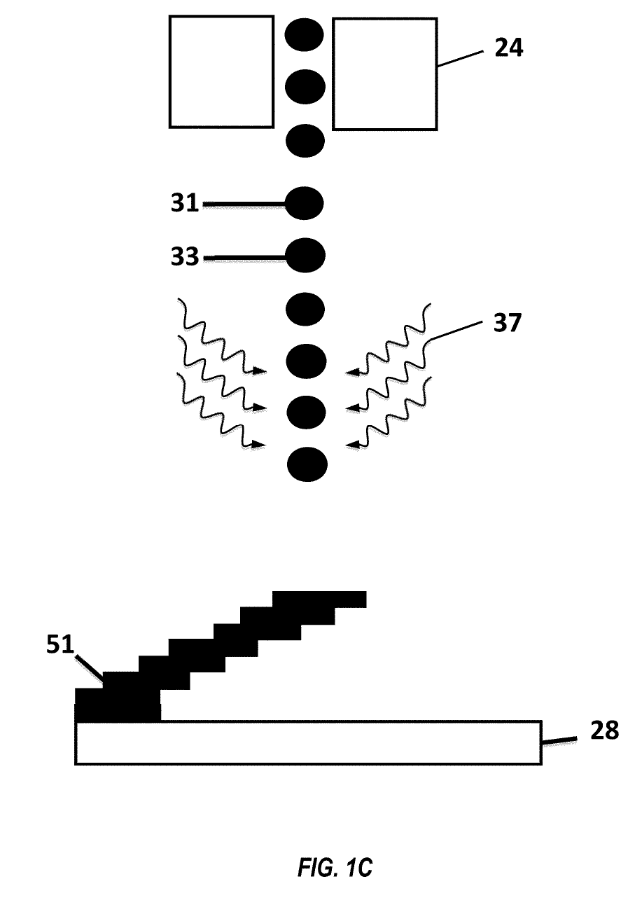

Aerosol Jet® printing is a non-contact, aerosol-based jetting technology. The starting inks are formulated with low viscosity (0.5 to 1000 cP) and in the typical process they are first aerosolized into a fine droplet dispersion of 1-5 μm diameter droplets. Preferably nitrogen gas entrains the droplets and propels them through a fine nozzle (0.1-1 mm inner diameter) to a target substrate for deposition. A co-flowing, preferably nitrogen sheath gas focuses the droplet jet down to a 10 μm diameter, which allows features of this size to be printed. The jetting technology is notable for the large standoff distance between the nozzle and substrate (several mm), the fine resolution (feature width 10 μm), volumetric dispense accuracy (10 femtoliter), and wide range of material compatibility. Because of the large standoff distance, it is possible to dry and/or otherwise cure the droplets during their flight to the substrate. In doing so, the viscosity of the droplets can be increased much beyond the starting viscosity. With higher viscosity, the printed inks are self-supporting and can be built up into free standing columns and other high aspect ratio features. In order to increase the viscosity, UV light from either a lamp or a UV LED is preferably applied to the interstitial region between the nozzle exit and the target substrate, as shown in FIGS. 1A-1C. If the starting ink comprises a photopolymer with an absorption band overlapping the UV emission spectrum, the UV light can either fully or partially cure the photopolymer droplet in-flight, thereby increasing the viscosity.

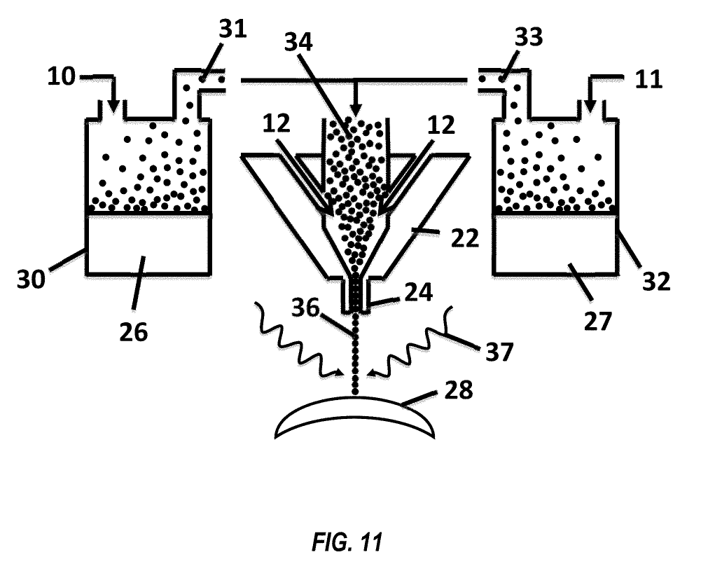

An embodiment of an apparatus of the present invention is shown in FIG. 11. Carrier gas 10 flows in the direction indicated by the arrow into first atomizer 30 and aerosolizes material 26 to form aerosolized material 31, such as a nanoparticle ink. Carrier gas 11 flows in the direction indicated by the arrow into second atomizer 32 and aerosolizes second material 27 to form aerosolized material 33. An ultrasonic aerosolizer is preferably used to aerosolize materials with a viscosity of 1-10 cP. A pneumatic aerosolizer is preferably used to aerosolize materials with a viscosity of 10-1,000 cP. Using a suitable dilutant, material with a viscosity greater than 1,000 cP may be modified to a viscosity suitable for pneumatic aerosolization. Aerosolized materials 31, 33 are propelled by the carrier gas, flow as indicated by the arrows via (for example) tubing to mixing chamber 34, where they combine. The aerosolized mixture then flows into deposition head 22. Sheath gas 12 flows in the directions indicated by the arrows into deposition head 22 and surrounds the combined aerosol stream to create a focused droplet jet 36. The droplet jet 36 exits the deposition nozzle 24, and in embodiments wherein the materials comprise photopolymers, the droplets are cured using light 37, for example UV light, which is shone in the direction indicated by the oscillating arrows, and then impact target 28. The distance between deposition nozzle 24 and target 28 can be any distance from 1 mm to as high as 10 mm, but is preferably between approximately 2 mm and 5 mm. Varying the relative carrier gas flows changes the relative deposition rates of the two materials. In one or more embodiments the two materials may comprise different refractive indices n1, n2.

FIG. 1A is a schematic illustrating a mechanism for three-dimensional printing with aerosol jets. Micro 3D structures are manufactured preferably by using Aerosol Jet® compatible low viscosity photocurable resins or photopolymers, which are preferably printed using the Aerosol Jet® technology described above. Electromagnetic radiation, in this case UV light, illuminates and partially cures the droplets mid-flight. The partial curing increases the viscosity of the photopolymer droplets, which in turn limits the spreading of the deposit on the target. The photopolymer droplets preferably coalesce on the target and then fully cure. FIG. 1B shows the photopolymer droplets comprising both materials 31, 33 stacking vertically to form deposit 50. Three-dimensional deposit 50 comprises compositionally graded material profiles, preferably achieved by varying the relative gas flow or powder feed rate of the different materials being co-deposited. The materials preferably comprise a mixture of particles and UV activated polymers. Curing the droplets on the fly between deposition nozzle 24 and target 28 helps to rapidly solidify materials 31, 33 in place without requiring sintering or heating of the target, which enables free standing graded 3D deposit 50 to be printed. Light 37 is preferably shone on both sides of the droplet stream and deposit for curing. The wavelength of the light 37 is preferably matched to activators such as UV activators in the polymer included in the materials. FIG. 1C shows the photopolymer droplets forming overhang structure 51 as the target 28 is translated beneath the deposition head. Alternatively, the deposition head may be moved while the target remains stationary. Up to 45 degree overhangs have been demonstrated, although even greater angles may be achieved.

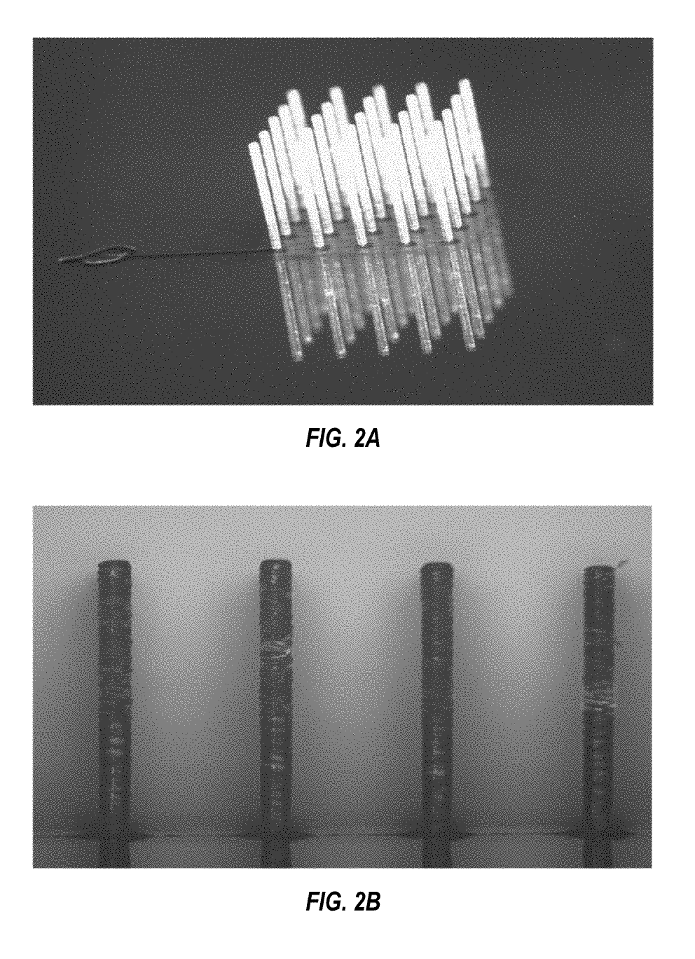

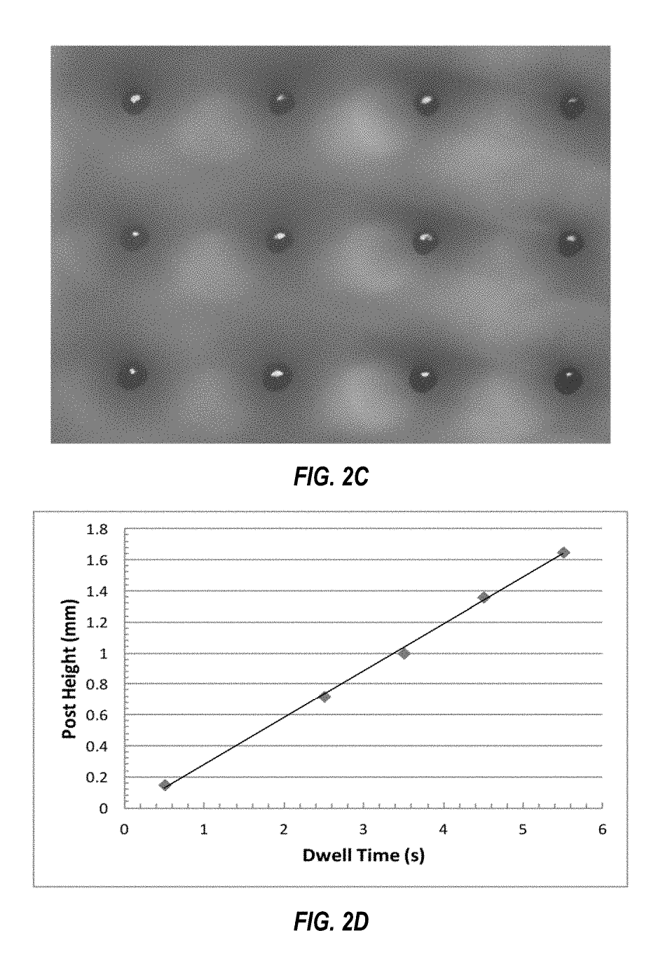

FIG. 2A is a photograph of vertical polymer posts printed with Loctite 3104 acrylic urethane and simultaneous UV LED curing. The incident UV power was 0.65 mW, the UV wavelength was 385 nm and volumetric print rate was 7.5 nL/s. The posts can extend from the target substrate substantially to the aerosol jet nozzle outlet. FIG. 2B is a magnified image of the post array; the post height is 1.0 mm, the height variation is 1%, the spacing is 0.5 mm, and diameter is 90 μm. FIG. 2C is an image of the top surface of the post array. The top of each post has a rounded, nearly hemispherical shape. FIG. 2D is a graph showing the measured build rate of a single post. The post height was found to be proportional to time when the print nozzle was stationary at a given location (i.e. the dwell time). The variation in height is approximately 1%, or alternatively approximately 10 μm for a 1.0 mm tall post.

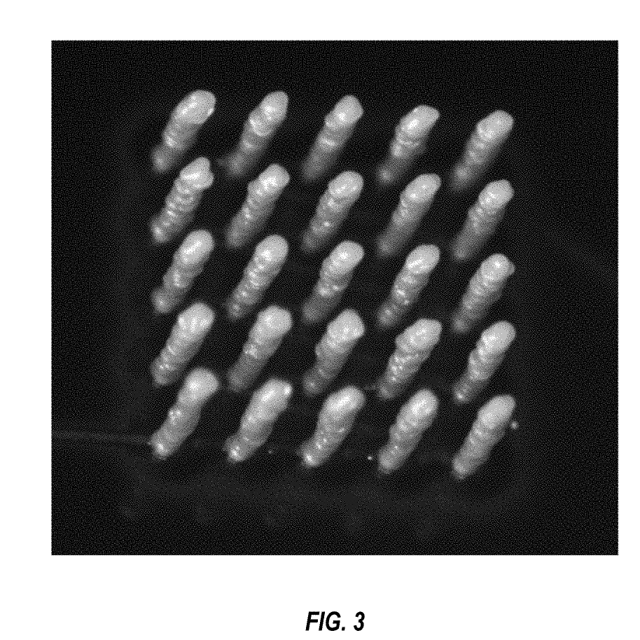

In-flight processing is also possible when solid particles, such as ceramics, metals, or fibers, are dispersed in the photopolymer ink. In this case, the cured photopolymer serves as a 3D mechanical support for the solid particles. The mechanical and electrical properties of this composite material can be optimized by, for example, providing wear and abrasion resistance, as well as forming 3D electrical conductors. FIG. 3 is an image of an array of composite posts. Silicon powder, having a particle size of less than 500 nm, was dispersed in a UV photopolymer resin at a concentration of 7% by volume. The composite dispersion was then printed and cured in-flight to produce solid posts of cured resin with embedded silicon. The post diameter is 120 μm and the height is 1.1 mm. Composite materials are desirable for optimizing mechanical and electrical properties of a 3D structure. In this example, the composition material is sufficiently transparent to the UV light such that it is fully cured, even with single sided UV illumination. At greater concentrations and with highly absorbing particles, the composite resin may be opaque to the incident light. In that case, it may be necessary to illuminate the printing area from opposite sides, or illuminate the deposit with a ring lamp. As long as the UV resin is curing near the outer surface of the 3D structure, sufficient mechanical support will allow the structure to build vertically. The photopolymer can optionally be removed in a post-processing step, such as by heating the 3D structure to beyond the evaporation or decomposition point of the photopolymer.

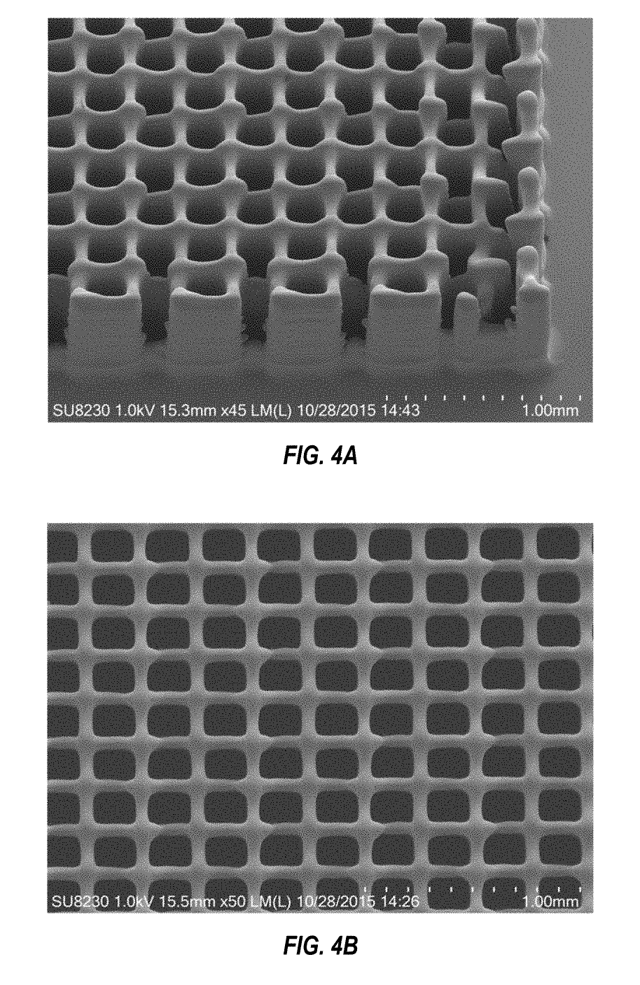

FIG. 4 shows images of a printed mechanical interposer, which is an element that provides structural support and precision spacing between two separated components. The interposer was printed by stacking multiple layers of UV resin, as can be seen in the perspective view of FIG. 4A. FIG. 4B shows the top surface grid pattern. In some embodiments, an interposer can provide electrical or fluidic routing between one element or connection to another, in which case the interstitial spaces could be filled with conductive material or fluids.

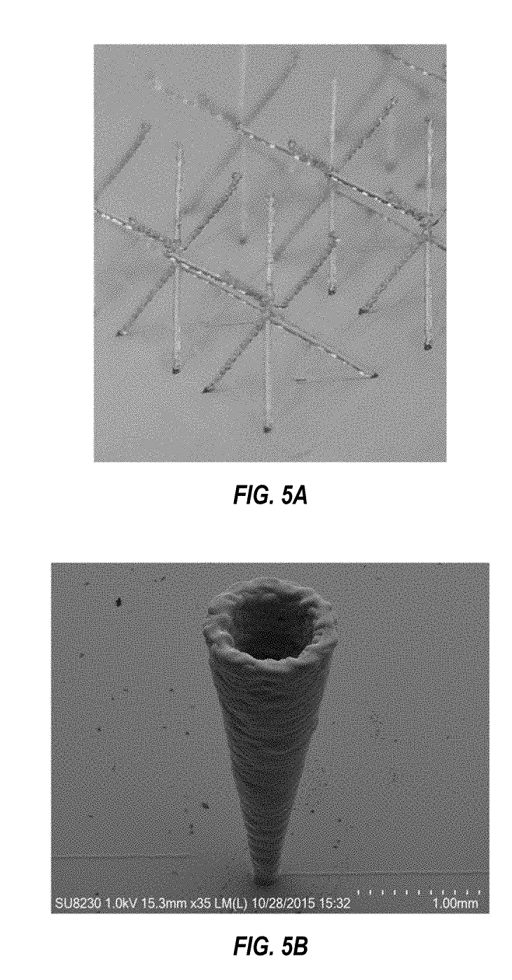

FIG. 5A shows three-dimensional jack-like structures printed using the offset approach shown in FIG. 1. The lower 4 legs were printed while translating the print head in x- and y- directions to a vertex point. The angled post is at an approximate 45-degree angle with respect to the substrate. The top legs were printed by translating the print head away from the vertex. The overall height is 4 mm and the individual post diameters are 60 μm. FIG. 5B shows an open cone structure. This was printed by translating the stage in a repeating circular motion with increasing radius. If desired the cone could be closed by continuing the circular motion and decreasing the radius to zero.

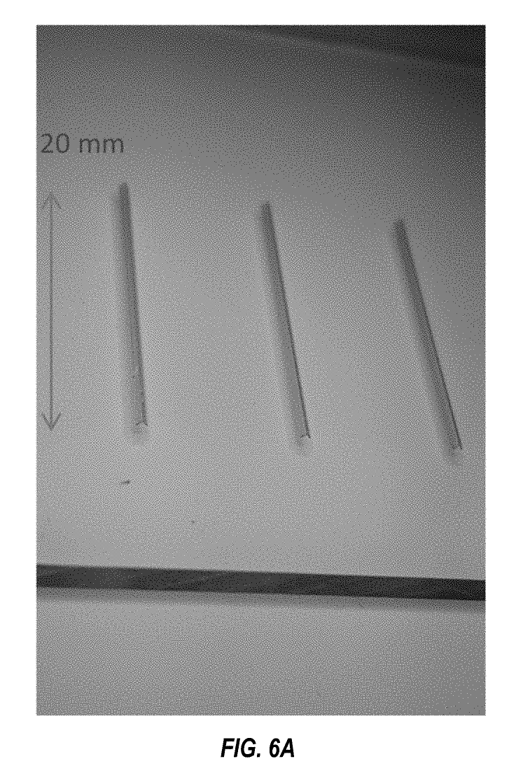

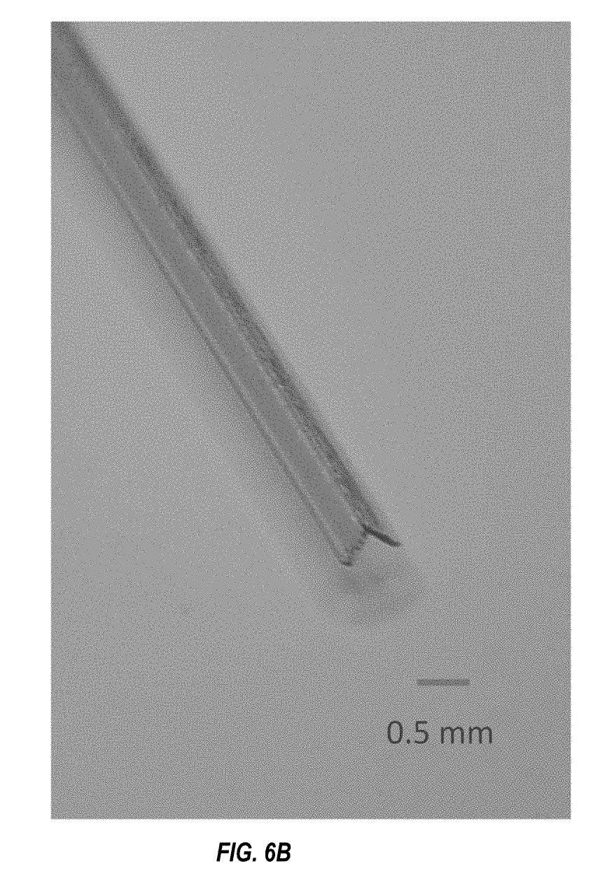

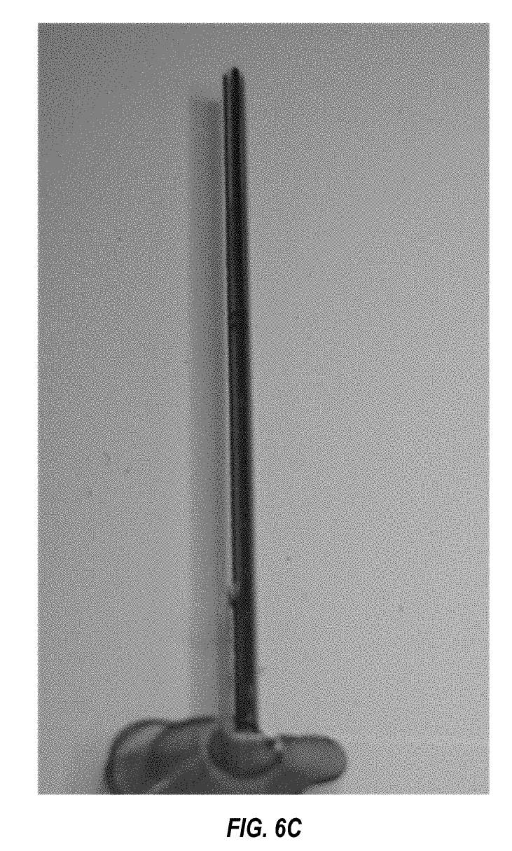

FIGS. 6A and 6B show a closed channel having an open interior along the length. Each sidewall of the channel was printed by stacking lines of photocurable polymer and sequentially offsetting by approximately ½ of a linewidth. This process resulted in a wall tilted at approximately 45 degrees in the direction of the offset. By offsetting in opposite directions, the walls touch at the midpoint. FIG. 6C depicts a drop of pigmented ink placed near the entrance to a channel, which is seen to be pulled through the channel by surface tension forces. This demonstrates that the channel is enclosed along the length but the channel is completely open from end to end.

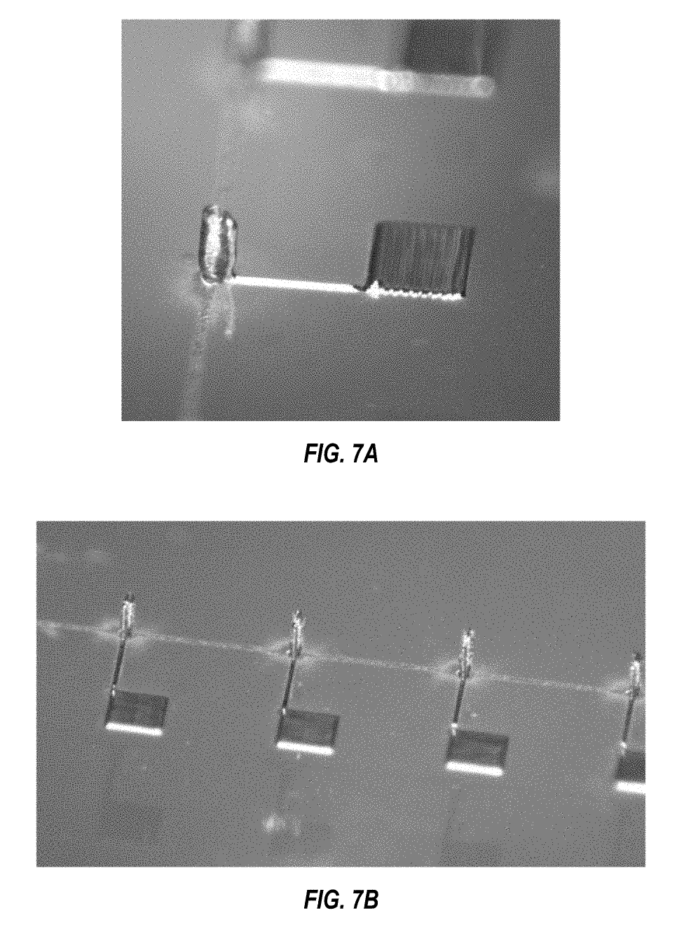

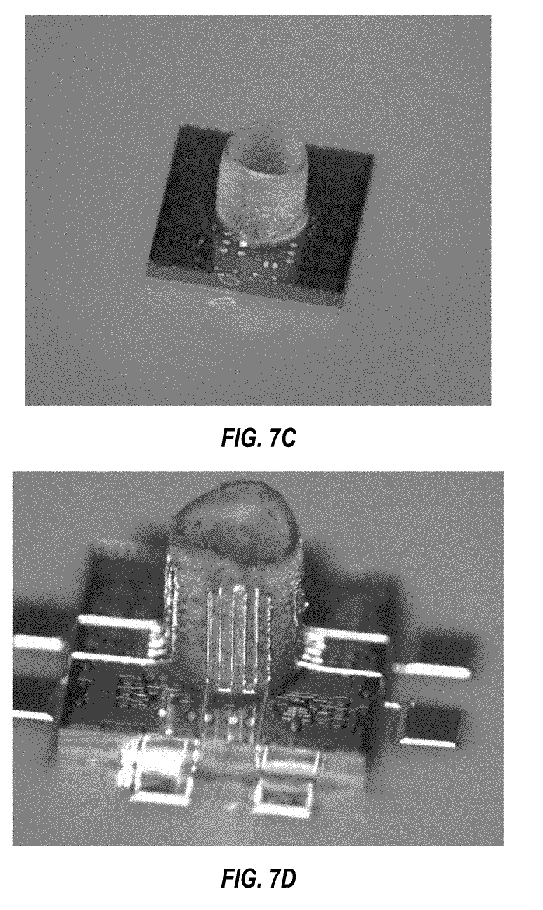

FIG. 7A shows a photocured post used as a mechanical support for an electrical component. The polymer post was fabricated using the process in FIG. 1 and it is approximately 1 mm tall by 0.1 mm wide. Silver ink was printed on the sidewall of the post and substrate by tilting the print head at 45 degrees with respect to each. The silver ink has low viscosity during printing and consequently will spread slightly on the substrate. By providing a mechanical support, the silver ink can be printed in three dimensions along the surface of the support. After printing, the silver ink was thermally sintered in a box oven at 150° C. for 60 minutes. The resulting conductive pattern serves as a freestanding, millimeter wave dipole antenna. FIG. 7B shows an array of micro-antennas. FIGS. 7C and 7D are images of 3D electrical components printed on a microchip. The process of the present invention eliminates complicated connections and waveguides that would otherwise have to be built into a package. This example shows that functional devices such as 3D electrical components (for example, heaters, antennas, and interconnects) can be printed directly on a driver chip.

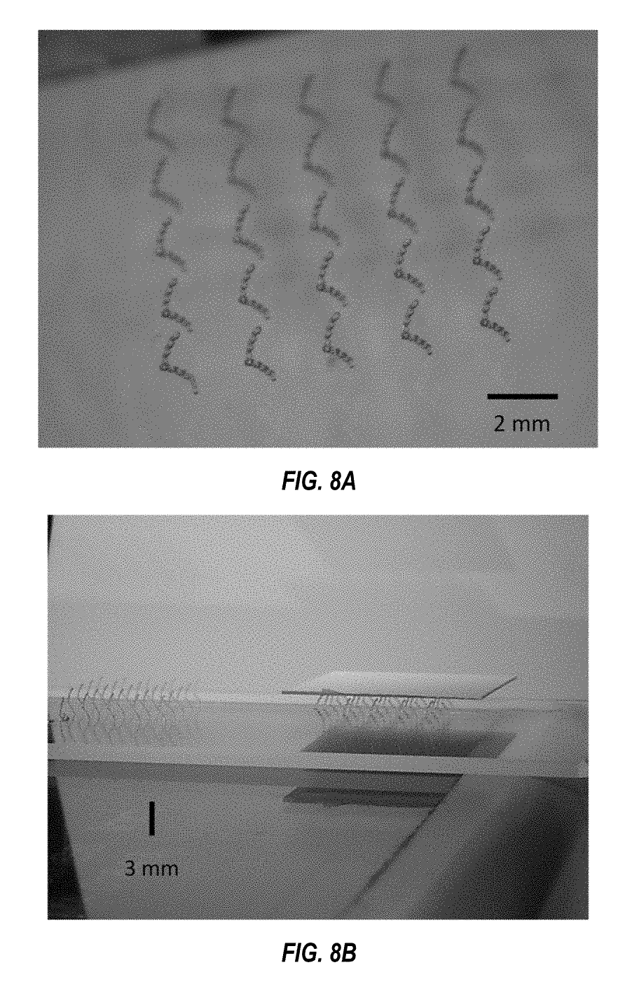

FIG. 8A shows freestanding polymer springs fabricated by tilting the print head during printing. The print head was tilted from 0° to −30° and back to 0° during build of each spring. FIG. 8B depicts a demonstration showing that the spring array can support a mechanical mass. In contrast to the vertical posts described previously, the springs provide a flexible interposer connection between two surfaces.

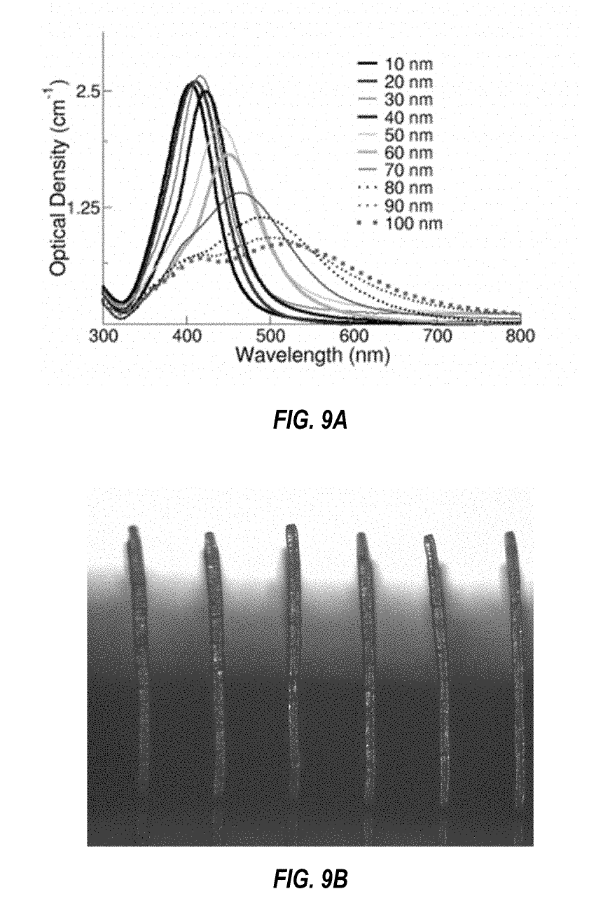

In the case of solvent based inks, such as metal nanoparticle dispersions, the droplet viscosity can be increased by partially or fully drying the droplet during flight. Since metal nanoparticles are known to be highly absorbing to UV light, exposing the droplets to UV illumination will heat the nanoparticles and accelerate the solvent evaporation. FIG. 9 shows such an extension of the in-situ curing process to non-photocurable materials. FIG. 9A is a graph showing the increasing optical density (i.e. absorption spectra) of silver nanoparticles at UV wavelengths as the particle size decreases. The curves are strongly peaked around 410 nm, but the absorption edge extends into the visible, making the in-flight processing possible with common UV LED and Hg lamps. Ink droplets comprising silver nanoparticles dispersed in a solvent can thus be heated by absorbing UV light at wavelengths near 400 nm. If heated in-flight, the solvent will largely evaporate and result in a highly concentrated silver drop when it impacts on a surface. The metal nanoparticle droplets can retain their 3D shape, both because the carrier solvent is evaporated and also because the particles are partially sintered. The now higher viscosity silver droplets can be stacked in 3D, similar to the stacking of the photopolymer. Further illumination after printing, which heats the nanoparticles beyond the level required for evaporating the solvent, will cause the nanoparticles to at least partially sinter and become conductive. FIG. 9B shows a 3D silver wire array printed with the in-situ illumination method. The wire width is 40 μm and the height is 0.8 mm. The wires are slightly bent due to the fact that only single sided illumination was used, which causes the wires to be heated more on the illumination side, leading to asymmetrical shrinkage.

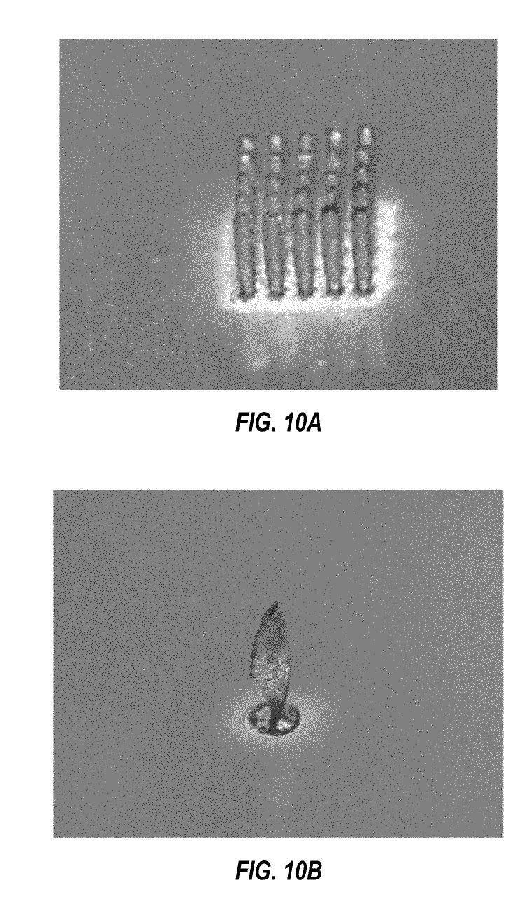

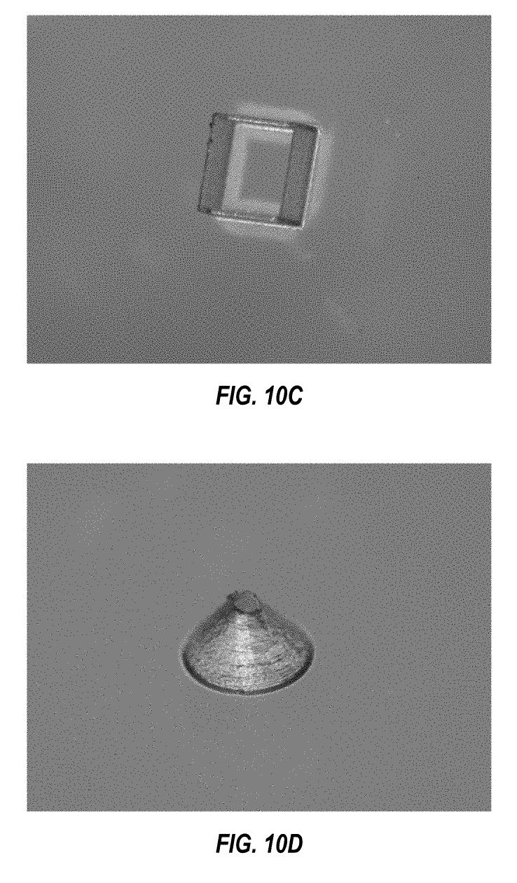

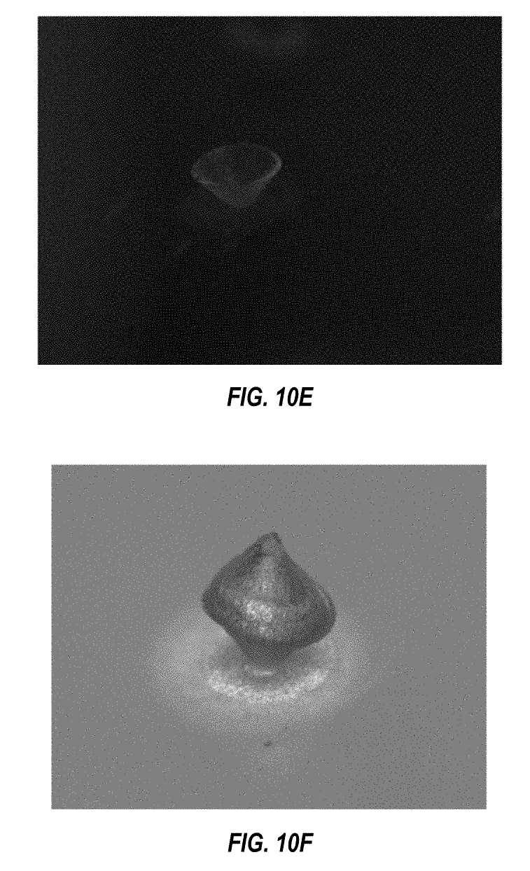

FIGS. 10A-10F are images of various 3D shapes printed using UV polymers and on the fly curing. FIG. 10A shows pillars (0.1 mm pitch, 0.25 mm tall). FIG. 10B shows a twisted sheet (0.5 mm width, 2 mm tall). FIG. 10C shows a box (1 mm length, 0.25 mm tall, 0.03 mm wall). FIG. 10D shows a hat (0.5 mm diameter, 0.5 mm tall). FIG. 10E shows a cone (0.5 mm diameter, 0.5 mm tall). FIG. 10F shows a bubble (0.5 mm diameter, 1 mm tall).

In embodiments of the present invention, UV illumination modifies the properties of aerosol droplets as they are jetted onto a target surface. In some embodiments the UV light at least partially cures photopolymer droplets, and the resulting increased viscosity facilitates the formation of free standing structures. In other embodiments the UV light rapidly dries droplets of solvent-based nanoparticle dispersions in flight, likewise enabling 3D fabrication. Thus 3D fabrication in accordance with the present invention can be performed using a wide variety of photopolymer, nanoparticle dispersion, and composite materials. The resulting 3D shapes can be free standing, without supports, and arbitrary shapes can be created by manipulating the print nozzle relative to the target substrate. The feature size is primarily determined by the jetting process, and can go down to 10 μm or even lower.

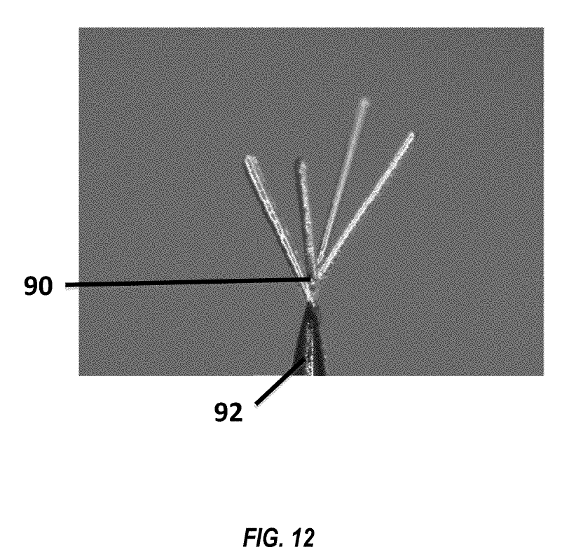

In the embodiment of the present invention shown in FIG. 12, acrylic posts 90, similar to those of FIG. 2A, were printed on the point of a needle 92. This demonstrates that the technology of the present invention can print 3D objects anywhere, including onto any other 3D surface. The print head can align to any surface and print at any angle onto that surface, as demonstrated by the varying angles of the acrylic posts 90 on the tip of needle 92. In competing technologies, it is often required that printing start from a flat bed or clean surface. The present invention can be used to build a 3D structure on any preexisting surface or part. Additionally, electronics may be printed onto 3D printed objects, combining structural 3D printed objects with 3D electronics using the same tool.

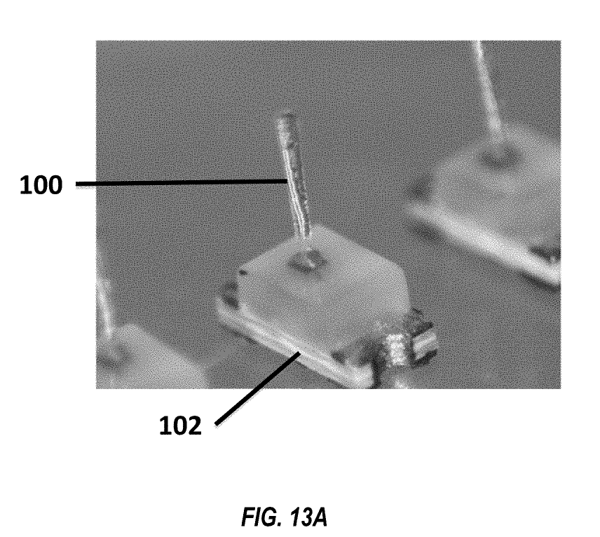

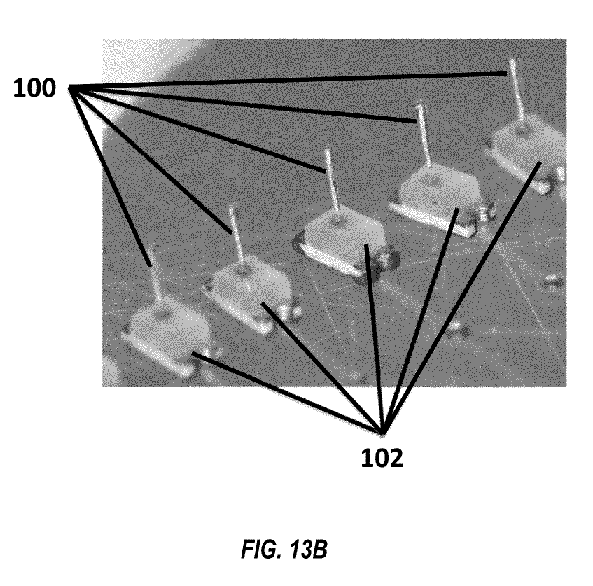

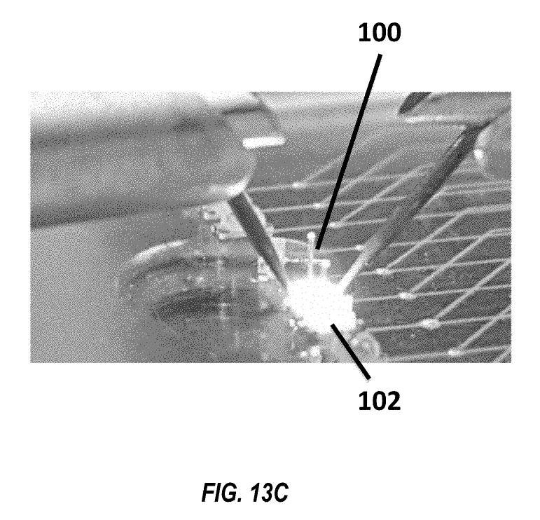

FIGS. 13A, 13B, and 13C show acrylic posts 100 formed on surface mounted light emitting diodes (LED's). In this embodiment of the present invention, the translucent acrylic post acts as a light pipe to guide light from one place to another, similar to an optical fiber. A light pipe is a cylinder of the same material, essentially a translucent pipe, that connects two optical devices and whose sole purpose is to transmit light between the two devices. The light pipes of the present invention can be straight, bent, or angled, in any combination. Such printed light pipes potentially eliminate manual connections and terminators on the optical fiber. Light pipes can have applications as optical interconnects between electronic chips for high speed, high bandwidth communication, strain sensors, fiber lasers, and optical filters.

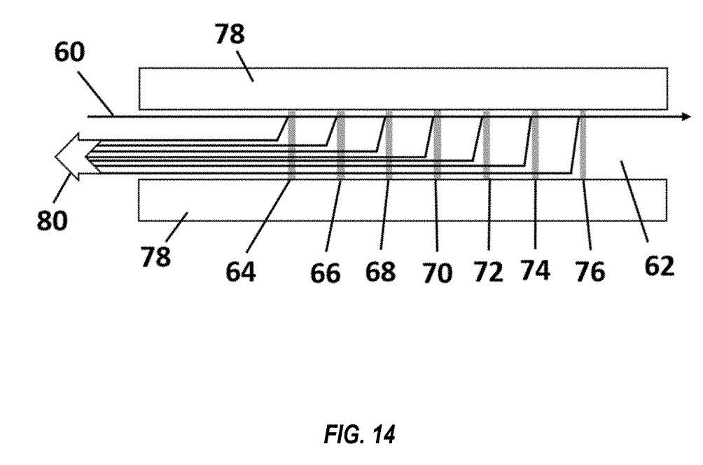

In one embodiment of the present invention, a light pipe or optical fiber can comprise modulations of the index of refraction of the polymer to make optical filters. These modulations reflect light at the point where the refractive index changes, and can preferably be used to create Bragg filters. Printed fibers fabricated in accordance with the present invention can be as small as 10 μm in diameter with or without material gradients. FIG. 14, illustrates an embodiment of such an optical fiber with a Bragg filter. Incident light 60 enters the optical fiber core 62 (i.e. the light pipe) and travels through optical filters 64, 66, 68, 70, 72, 74, 76. Optical filters 64, 66, 68, 70, 72, 74, 76 preferably have differing optical indices and thereby reflect different wavelengths of light 80, resulting in the desired constructive and/or destructive interference. A metallic, reflective material can be substituted for one of the transparent optical materials in cases where high optical reflectance is needed. Alternatively, a fluorescent material can be substituted for or added to one of the transparent optical materials in cases where light generation within the fiber is needed.

Material gradients along the fiber length preferably comprise a lower limit of spatial variance, or spacing between the filters, of 10 nm. For some optical Bragg filters 64, 66, 68, 70, 72, 74, 76 the optimal spatial variance is preferably 250 nm, approximately one-half the wavelength of visible light. The material gradient along the length of the fiber can vary sinusoidally if the materials are mixed by varying the aerosol gas flows. Alternatively, the material gradient can occur in discrete steps if the materials are mixed by pulsing the flows. The material gradient amplitude can vary from 0 to 100% depending on the relative amounts of material fed from each atomizer.

Optional optical cladding 78 can be applied to the outside of the optical fiber to improve light containment inside core 62 of the optical fiber. The optical cladding preferably has a lower refractive index than the two (or more) materials used for the core. For example, optical cladding 78 could be printed in a spiral to make a hollow cylinder followed by printing the core 62 with one or more material gradients along the fiber axis. The roughness of the fiber sidewall and optical cladding 78 is preferably below 1 micron, facilitating containment of light within the core via total internal reflection. Optical fiber materials preferably comprise transparent photopolymers that have differing refractive indices necessary for controlled optical reflection, yet similar chemistries; for example, they are preferably miscible and/or have similar UV curing properties.

In another embodiment of the present invention, optical interconnects for data transmission, for example in integrated circuits, can be fabricated. Optical interconnects are essentially optical fibers and may comprise graded or ungraded material that optically connect electronic chips. Data transmission in CMOS submicron chip technology is limited by the standard on-chip communication via interconnects. Chip-to-chip data transmission can be greatly increased by using optical interconnects instead of the traditionally used metal interconnects. For example, a vertical cavity surface emitting laser (VCSEL) can be used as an optical interconnect. The on-chip light source can optionally be connected to an on-chip light detector via printed light pipe or optical fiber as described in the present invention.

Another embodiment of the present invention is a flat lens that has the ability to bend and focus light using materials gradients. Traditionally, lenses are not flat and require their shape to be convex or concave in order to bend light. A flat lens that focuses light preferably comprises a relatively high refractive index material at the edge and a relatively low refractive index material at the center. This radial refractive index material grading from low at the center to high at the edge bends light even though the lens maintains a flat shape.

In another embodiment of the present invention, acoustic gradients can be printed. Graded acoustic fibers, for example ultrasound sensors, can be connected with 3D interconnects. Ultrasonic transducers preferably allow sound to travel into tissue and not be reflected. For example, acoustic impedance matching can be achieved by physically grading a high-density transducer, for example a Positive Temperature Coefficient (PTC) ceramic, with a low-density transducer, for example a material with a density similar to that of tissue.

Alternatives to Electromagnetic Radiation Curing of Polymers

Aerosol Jet® fabricated, high aspect ratio 3D structures can be obtained using any rapidly solidifying materials. A material that is rapidly solidifying preferably has a dry time that is shorter than the time for mixing or dissolving, t_{dry}<t_{dissolve}. For example, quick evaporating solvents can be used in place of a curable polymer as the suspension medium.

Another alternative is pseudoplastic fluids, for example shear thinning fluids. Shear thinning fluids are fluids where the shear viscosity decreases with applied shear strain. Shear viscosity, ηq, is related to the applied shear rate through the equation:

η=kΓⁿ⁻³¹

where η is the viscosity, K is a material based constant, Γ is the applied shear rate, and n is the flow behavior index. Shear thinning behavior occurs when n is less than 1. Shear thinning fluids have lower viscosities (more liquid like) when sheared and immediately become more viscous once the shearing ceases. This immediate change in viscosities makes it suitable for printing high aspect ratio 3D structures using the Aerosol Jet® technology described within.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method for fabricating a three-dimensional structure on a substrate, the method comprising:
aerosolizing a first material and a second material;
mixing droplets comprising the first material with droplets comprising the second material to form a mixed aerosol;
propelling droplets of the mixed aerosol from a deposition head toward the substrate;
partially modifying a property of the mixed aerosol droplets in-flight; and
fully modifying the property of the mixed aerosol droplets once they have been deposited as part of the three-dimensional structure.

2. The method of claim 1 wherein the aerosol droplets comprise a photocurable polymer and modifying a property comprises curing or solidifying using electromagnetic radiation.

3. The method of claim 2 wherein the fabricated three-dimensional structure comprises a light pipe or an optical fiber.

4. The method of claim 3 wherein the first and second materials have different refractive indices.

5. The method of claim 4 wherein the mixing step comprises varying the relative amounts of the first and second materials.

6. The method of claim 5 wherein the light pipe or optical fiber comprises a periodic variation of the relative compositions of the two materials along a length of the light pipe or optical fiber.

7. The method of claim 6 wherein the light pipe or optical fiber comprises a Bragg grating.

8. The method of claim 7 wherein one of the materials is reflective or fluorescent.

9. The method of claim 3 wherein an exterior surface of the light pipe or optical fiber comprises optical cladding.

10. The method of claim 9 wherein a roughness of the exterior surface and/or the optical cladding is less than one micron.

11. The method of claim 9 wherein the optical cladding has a lower refractive index than both a refractive index of the first material and a refractive index of the second material.

12. The method of claim 1 wherein the three-dimensional structure comprises an optical interconnect.

13. The method of claim 1 wherein the mixing step comprises varying the relative amounts of the first and second materials.

14. The method of claim 6 wherein the three-dimensional structure comprises compositionally graded material profiles and/or materials gradients.

15. The method of claim 14 wherein the three-dimensional structure comprises a flat lens comprising a first refractive index at an edge of the lens and a second refractive index at a center of the lens.

16. The method of claim 1 wherein the aerosol droplets comprise a solvent and modifying a property comprises evaporating the solvent.

17. The method of claim 16 wherein the aerosol droplets comprise metal nanoparticles, the method further comprising:
irradiating the aerosol droplets with UV radiation;
heating the metal nanoparticles; and
heating the aerosol droplets sufficiently to at least partially evaporate the solvent; and
continuing to irradiate the metal nanoparticles after they have been deposited, thereby at least partially sintering the metal nanoparticles.

18. The method of claim 1 further comprising tilting or translating the deposition head with respect to the substrate.

19. The method of claim 1 comprising fabricating an overhanging structure without requiring a sacrificial support or tilting the deposition head or the substrate.

20. The method of claim 1 wherein the standoff distance between the deposition head and the substrate is at least 1 mm.

21. The method of claim 20 wherein the standoff distance between the deposition head and the substrate is between 2 mm and 5 mm.

22. The method of claim 1 comprising increasing the viscosity of the aerosol droplets in-flight.
